(19) United States
(12) Patent Application Publication
(10) Pub. No.: US 2018/0020650 A1
(43) Pub. Date: Jan. 25, 2018

(54) Fishing Bait Cooler Device

(71) Applicant: Jimmy Bliss, Portland, TX (US)

(72) Inventor: Jimmy Bliss, Portland, TX (US)

(21) Appl. No.: 15/218,805

(22) Filed: Jul. 25, 2016

(51) Int. Cl. A01K 97/04

(52) U.S. Cl. CPC A01K 97/04

(57) ABSTRACT

A fishing bait cooler device stores bait worms in a cool environment and facilitates access to the worms. The device includes a bottom container defining an interior space for holding a cold material and a top container defining a storage space for holding soil and bait worms. A panel is coupled to the top container and adjustable between a closed position and an open position exposing the storage space. The top container is coupled to the bottom container and adjustable between an access position and a storage position. The top container is positioned in abutment and is aligned with the bottom container in the storage position. The panel is exposed in the access position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cooler devices and more particularly pertains to a new cooler device for storing bait worms in a cool environment and facilitating access to the worms.

### BRIEF SUMMARY OF THE INVENTION

An embodiment of the disclosure meets the needs presented above by generally comprising a bottom container defining an interior space for holding a cold material and a top container defining a storage space for holding soil and bait worms. A panel is coupled to the top container and adjustable between a closed position and an open position exposing the storage space. The top container is coupled to the bottom container and adjustable between an access position and a storage position. The top container is positioned in abutment and is aligned with the bottom container in the storage position. The panel is exposed in the access position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a fishing bait cooler device according to an embodiment of the disclosure.

FIG. 2 is a top front side perspective view of an embodiment of the disclosure with an access panel being open.

FIG. 3 is a top front side perspective view of an embodiment of the disclosure in an open in use position.

FIG. 4 is a top front side perspective view of an embodiment of the disclosure in a closed position.

### DETAILED DESCRIPTION OF THE INVENTION

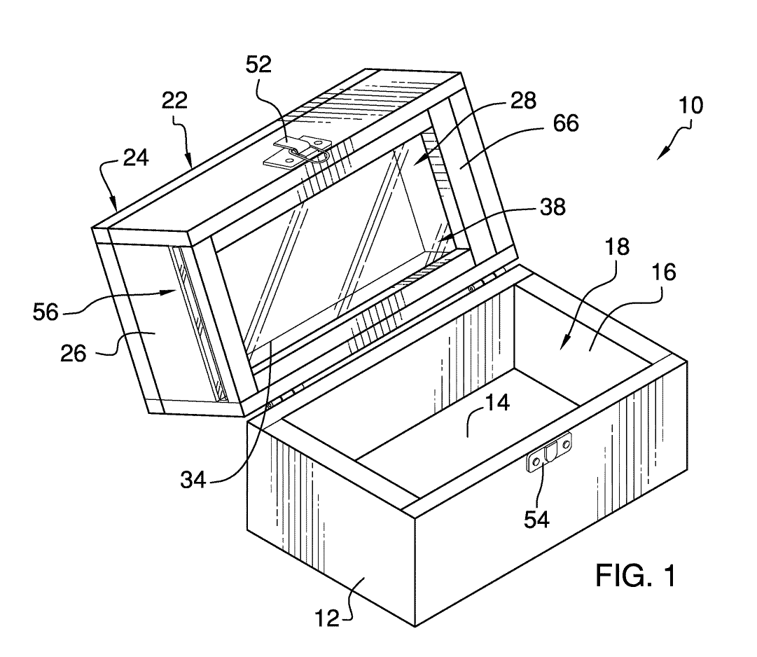

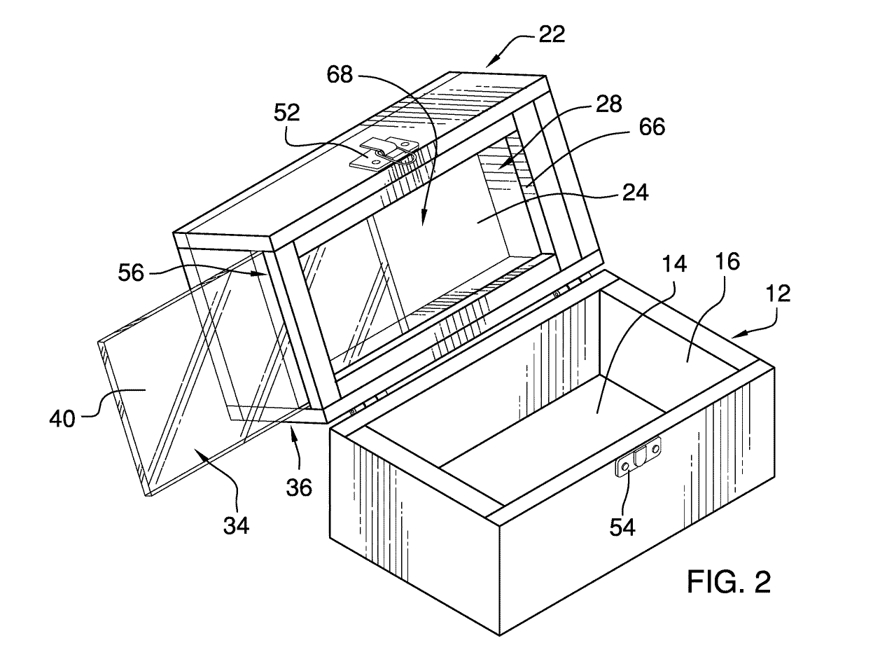

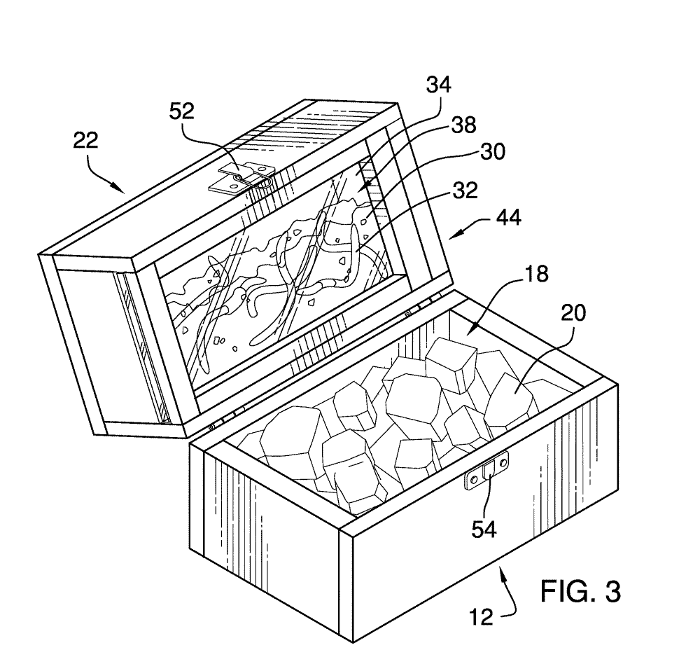

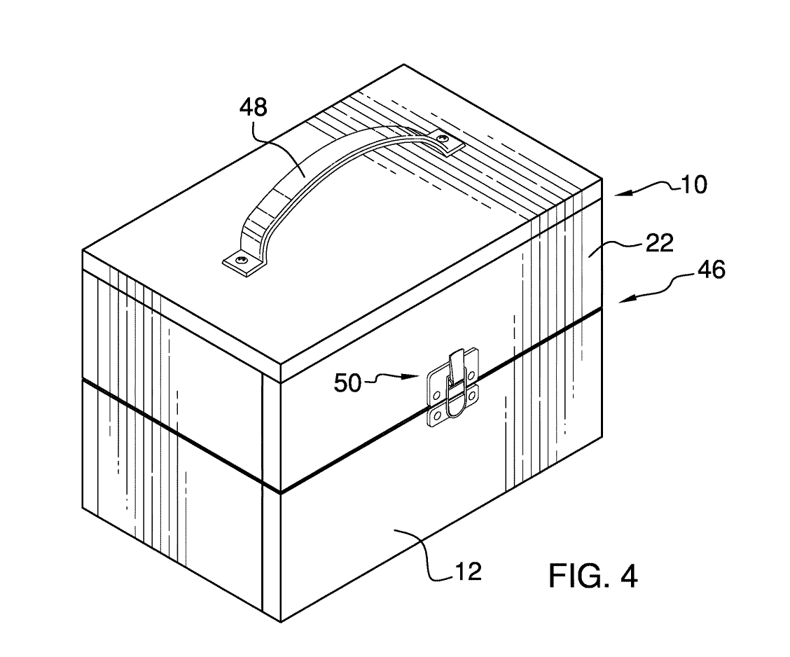

With reference now to the drawings, and in particular to FIGS. 1 through 4 thereof, a new cooler device embodying the principles and concepts of an embodiment of the disclosure and generally designated by the reference numeral 10 will be described.

As best illustrated in FIGS. 1 through 4, the fishing bait cooler device 10 generally comprises a bottom container 12 having a bottom wall 14 and a perimeter wall 16 coupled to and extending upwardly from the bottom wall 14 to define an interior space 18 of the bottom container 12. The interior space 18 is configured for holding a cold material 20 such as ice, dry ice, cold packs, freezable gel, or the like as conventionally used in coolers. The bottom container 12 is insulated in a conventional manner to preserve coldness of the cold material 20 and slow heat dissipation through the bottom container 12.

A top container 22 has a top wall 24 and a peripheral wall 26 coupled to and extending from the top wall 24 defining a storage space 28 in the top container 22. The storage space 28 is configured for holding soil 30 and bait worms 32, or a similar bait for fishing, within the storage space 28. The top container 22 is also insulated in a conventional manner. A panel 34 is coupled to the top container 22. The panel 34 is adjustable relative to the top container 22 such that the panel 34 is adjustable between an open position 36 exposing the storage space 28 and a closed position 38 enclosing the storage space 28. The contents of the top container 22 are held within the storage space 28 by the panel 34 when the top container 22 is in an inverted position. The panel 34 is constructed of acrylic sheeting 40, such as known under the trade name PLEXIGLASS. The panel 34 is transparent allowing the contents within the storage space 28 to be viewed through the panel 34. A slot 56 extends through the peripheral wall 26 of the top container 22. The panel 34 is slidable through the slot 56 between the open position 36 and the closed position 38. A lip 66 is coupled to the peripheral wall 26 and extends into an opening 68 into the storage space 28. The lip 66 is in abutment with the panel 34 when the panel 34 is in the closed position 38 to facilitate retention of the contents within the storage space 28.

The top container 22 is hingedly coupled to the bottom container 12 wherein the top container 22 is adjustable between an access position 44 and a storage position 46. The top container 22 is positioned in abutment and is aligned with the bottom container 12 in the storage position 46. The panel 34 is exposed in the access position 44. A handle 48 is coupled to the top wall 24 of the top container 22. A latch 50 has a first section 52 coupled to the top container 22 and a second section 54 coupled to the bottom container 12. The first section 52 couples to the second section 54 whereby the top container 22 is secured in the storage position 46.

In use, the bottom container 12 is filled with the cold material 20 and the storage space 28 is filled with the soil 30 and bait worms 32. The panel 34 is placed into the closed position 38. The top container 22 is maintained in an inverted position with the panel 34 facing the bottom container 12. The bait worms 20 are preserved by the cold material 20 and naturally migrate towards the panel 34 when the top container 22 is inverted. When the bait worms 32 are needed, the top container 22 is pivoted into the access position 44 and the panel 34 is moved to the open position 36. The bait worms 32 will be accessible in the area of the soil adjacent to the lip 66 such that substantial amounts of digging through the soil 30 is not required to remove a bait worm 32 from the storage space 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing bait cooler device comprising:
a bottom container, said bottom container having a bottom wall and a perimeter wall coupled to and extending upwardly from said bottom wall to define an interior space of said bottom container, said interior space being configured for holding a cold material;
a top container, said top container having a top wall and a peripheral wall coupled to and extending from said top wall defining a storage space in said top container, said storage space being configured for holding soil and bait worms within the storage space;
a panel coupled to said top container, said panel being adjustable relative to said top container such that said panel is adjustable between an open position exposing said storage space and a closed position enclosing said storage space; and
wherein said top container is coupled to said bottom container such that said top container is adjustable between an access position and a storage position, said top container being positioned in abutment and being aligned with said bottom container in said storage position, said panel being exposed in said access position.

2. The device of claim 1, further comprising said top container being hingedly coupled to said bottom container.

3. The device of claim 1, further comprising said top container being insulated.

4. The device of claim 1, further comprising said bottom container being insulated.

5. The device of claim 1, further comprising each of said top container and said bottom container being insulated.

6. The device of claim 1, further comprising a handle coupled to said top wall of said top container.

7. The device of claim 1, further comprising a latch having a first section coupled to said top container and a second section coupled to said bottom container, said first section coupling to said second section whereby said top container is secured in said storage position.

8. The device of claim 1, further comprising a slot extending through said peripheral wall of said top container, said panel being slidable through said slot between said open position and said closed position.

9. The device of claim 1, further comprising said panel being constructed of acrylic sheeting.

10. The device of claim 1, further comprising said panel being transparent.

11. The device of claim 8, further comprising a lip coupled to said peripheral wall and extending into an opening into said storage space.

12. A fishing bait cooler device comprising:
a bottom container, said bottom container having a bottom wall and a perimeter wall coupled to and extending upwardly from said bottom wall to define an interior space of said bottom container, said interior space being configured for holding a cold material, said bottom container being insulated;
a top container, said top container having a top wall and a peripheral wall coupled to and extending from said top wall defining a storage space in said top container, said storage space being configured for holding soil and bait worms within the storage space, said top container being insulated;
a panel coupled to said top container, said panel being adjustable relative to said top container such that said panel is adjustable between an open position exposing said storage space and a closed position enclosing said storage space, said panel being constructed of acrylic sheeting, said panel being transparent; and
said top container being hingedly coupled to said bottom container wherein said top container is coupled to said bottom container such that said top container is adjustable between an access position and a storage position, said top container being positioned in abutment and being aligned with said bottom container in said storage position, said panel being exposed in said access position;
a handle coupled to said top wall of said top container;
a latch having a first section coupled to said top container and a second section coupled to said bottom container, said first section coupling to said second section whereby said top container is secured in said storage position;
a slot extending through said peripheral wall of said top container, said panel being slidable through said slot between said open position and said closed position; and
a lip coupled to said peripheral wall and extending into an opening into said storage space.
